(19) United States
(12) Patent Application Publication
(10) Pub. No.: US 2009/0025274 A1
(43) Pub. Date: Jan. 29, 2009

(54) ANIMAL TRAP

(76) Inventor: Tim Lail, Hickory, NC (US)

Correspondence Address: MACCORD MASON PLLC, 300 N. GREENE STREET, SUITE 1600, P. O. BOX 2974, GREENSBORO, NC, 27402, US

(21) Appl. No.: 11/781,474

(22) Filed: Jul. 23, 2007

(51) Int. Cl. A01M 23/08

(52) U.S. Cl. 43/67; 43/65

(57) ABSTRACT

A trap for placing in the water and catching animals is shown and described. The trap includes a float configured to provide a buoyancy when floating in the water. A substantially vertical chute connects to the float. A portion of the chute enters the water and a portion of the chute rides above the water. An animal entrance is positioned on the top portion of the chute and a chamber is positioned on the bottom portion of the chute. When an animal enters the trap through the entrance, the buoyancy of the float raises the entrance to a height that the trapped animal is unable to access.

### BACKGROUND

(1) Field of the Invention

The present invention relates generally to animal traps, and, more particularly, to an aquatic trap designed to capture aquatic animals and help control their local population size.

(2) Related Technology

Aquatic animals, particularly aquatic mammals, e.g., muskrats and beavers, are notorious for the damage they can do to waterside property. Muskrats, for example, dig extensive tunnel systems in ground adjacent to the water's edge. Most often, the expansiveness or location of these tunnel systems are difficult to determine because entrances are located below water level.

Over short periods of time, such tunnels can result in structural damage to levees, dams, retaining walls, etc., and cause them to collapse upon themselves. Muskrats can also cause damage to boats and personal water craft by chewing through hulls or other parts. Besides the structural damage caused by muskrats, they also pose a safety risk to people who live near the water or visit the water and risk falling into sinkholes created by muskrat tunnels. Because they cause damage and represent a safety threat, muskrat control measures are often taken.

Often times, people will attempt to control muskrat populations by setting metal traps near muskrat tunnels. These traps may be somewhat successful, but they can also be tedious and dangerous to employ. At lakeside homes, retreats, and recreational areas, however, where swimmers may be playing in the water, traditional metal traps are extremely undesirable because the represent a potential safety hazard to those who may be cut or trapped by them. Other methods of muskrat control, such as shooting with shotguns or .22 caliber rifles, are similarly undesirable in residential and resort areas.

Others may have similar problems with other animals, e.g. beavers, minks, turtles, etc., and the present invention may be used as needed to address those problems as well.

### SUMMARY OF THE INVENTION

The present invention is directed to those and additional problems. By way of example, it provides, inter alia, an effective method of trapping animals that can be used with swimmers and children in the water nearby.

In brief summary, one embodiment of the invention includes a trap for placing in the water and catching animals. The trap includes a float configured to provide a buoyancy when floating in the water. A substantially vertical chute connects to the float. A portion of the chute enters the water and a portion of the chute rides above the water. An animal entrance is positioned on the top portion of the chute and a chamber positioned on the bottom portion of the chute. When an animal enters the trap through the entrance, the buoyancy of the float raises the entrance to a height that is out of reach of the trapped animal. The animal is quickly drowned and can be easily disposed of with little or no danger to those in the water.

The above summary was intended to summarize certain embodiments of the present invention. Embodiments of the present invention will be set forth in more detail, along with discussion of efficacy, in the figures and detailed description below. It will be apparent, however, that the detailed description is not intended to limit the present invention, the scope of which should be properly determined by the appended claims.

### BRIEF DESCRIPTION OF THE DRAWINGS

FIGS. 1a and 1b show side views on one embodiment of the present invention;

FIG. 2 shows a perspective view of the embodiment of FIGS. 1a and 1b; and

FIGS. 3a, 3b, and 3c show an embodiment of the present invention in operation.

### DESCRIPTION OF THE PREFERRED EMBODIMENTS

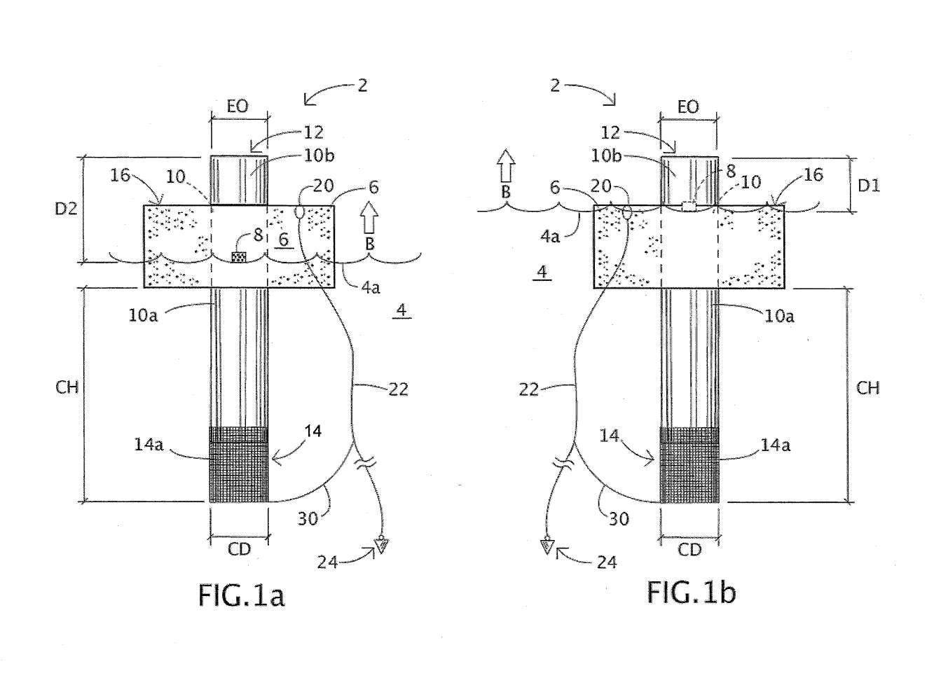

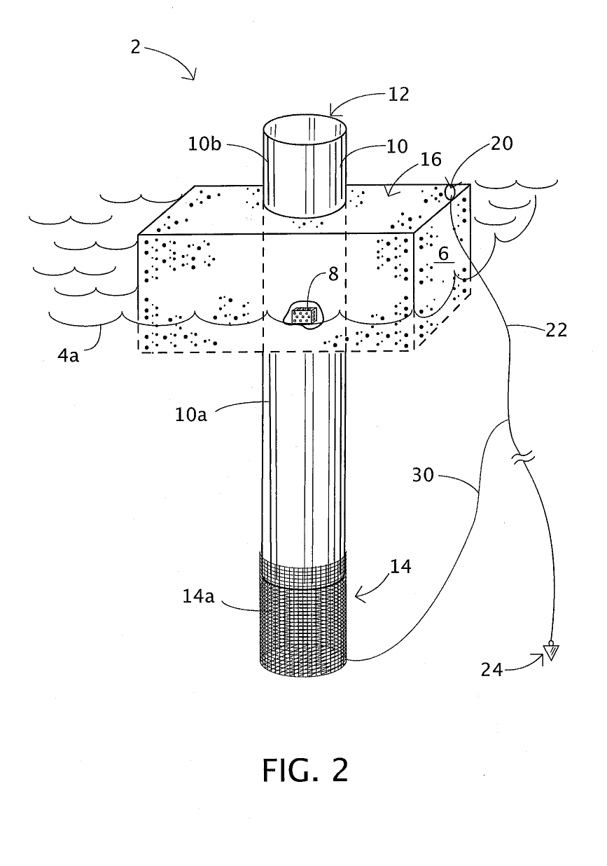

FIGS. 1a and 1b show two side views of one embodiment of a trap of the present invention floating at two different levels in a body of water. FIG. 2 shows a perspective view of the trap of FIG. 1. Referring generally to FIGS. 1a, 1b, and 2, a trap 2 of one embodiment of the present invention is shown floating in a body of water 4 having a water line 4a. Trap 2 includes float 6, chute 10, animal entrance 12, and chamber 14. Bait 8 is shown floating on water line 4a within trap 2.

Float 6 preferably includes deck 16, which is, in most embodiments, substantially adjacent to and offset from portions of chute 10. Deck 16 is configured, e.g., by being substantially horizontally positioned, to allow animals to position themselves upon float 6 and gain entrance to animal entrance 12. Deck 16 may be oriented at a greater or lesser angle relative to an artificial horizon, for example to make it easier or more difficult to gain access to said deck, and such embodiments are considered to be within the scope of the present invention. Similarly, the size of deck 16 is preferably such that an animal can position itself thereupon, for example, if the animal was a muskrat approximately 4 to 20 square inches may provide sufficient space. With larger animals, e.g., a beaver, a larger deck size may be required, e.g., approximately 25 to 100 square inches.

Deck 16 is also configured to provide an upward buoyancy force, or simply buoyancy B, when floating in water 4. Buoyancy B is selected to allow float 6 to float at a first level, for example the level shown in FIG. 1b, when an animal is positioned on deck 16 and at a second higher level, for example the level shown in FIG. 1a, when an animal is not positioned on deck 16. Buoyancy B is preferably selected to allow an animal to gain access to animal entrance 12 when the float is at the first level, e.g., shown in FIG. 1b, and selected to prevent an animal positioned in chamber 14 from escaping from chamber 14 out entrance 12 when float 6 is at the second level. For example, as shown in FIG. 1b, buoyancy B may be such that the distance D1 between entrance 12 and water line 4a is about 0.5 to about 12 inches, which is a range sufficient, Applicant believes, to allow a variety of animals, e.g., mice, rats, beavers, etc., to gain access to entrance 12. In some embodiments, it may be desirable to adjust D1. For example, D1 may be about 3 to about 9 inches, for, for example, muskrat-sized animals (approximately 3 to 4 pounds). Yet Applicant prefers, for animals of this size, a D1 of about 4 to 6 inches. For larger animals, Applicant prefers a larger D1. When floating baits 8 are used, distance D1 is also the distance from floating bait 8 to entrance 12, which allows bait 8 to appear within easy grasp to animals positioned upon float 6, thereby enticing animals into the trap.

When float 6 is at the second level, for example, as shown in FIG. 1a, buoyancy B may be such that the distance D2 between water line 4a and entrance 12 is sufficient to prevent animals located within chamber 14 from exiting through entrance 12. In many embodiments it will be preferable to configure trap and select buoyancy such that D2 is about 3 inches to about 24 inches. More specifically, D2 for traps configured for animals approximately the size of muskrats will be approximately 6 inches to 18 inches, about 9 to about 15 inches, preferably about 10 to about 14 inches, and most preferably for muskrat sized animals, about 10 to about 14 inches, which Applicant has determined empirically is a sufficient distance to prevent muskrats from exiting through said animal entrance. Others may prefer other distances, which are within the scope of the present invention.

Buoyancy can be determined as follows:

F(buoyancy)=−ρVg

where ρ is the density of the fluid; V is the volume of the object submerged; g is the standard gravity (9.81 N/kg on Earth). Thus, volume may be taken into consideration when determining buoyancies sufficient to practice various embodiments of the present invention. It should be understood, however, that float 6 of the present invention can be constructed to have a range of volumes, with the volume of the submerged portion of the float depending to a certain extent upon the design choice employed. For example, floats may have a length and a width of about 10 inches to about 36 inches and a height of about 4 inches to about 14 inches, or about 6 inches to about 10 inches. Smaller embodiments may have a length and a width of about 10 inches to about 24 inches and a height of about 4 inches to about 14 inches. Applicant believes sufficient float volumes (in terms of, e.g., total displacement) may be about 500 cubic inches to about 5000 cubic inches depending on the target animal, for example with larger animals, e.g., beavers being on the larger end of the scale. In some embodiments, a float volume of about 1000 cubic inches to about 4000 cubic inches, may be preferable, or a volume of about 1000 cubic inches to about 3000 cubic inches.

In embodiments preferred for muskrat-sized animals, Applicant prefers a volume of about 2000 cubic inches to about 2800 cubic inches, even more preferably, about 2100 to about 2600 cubic inches. Applicant prefers to achieve such volumes by using a float having a length and a width of about 12 inches to about 20 inches and a height of about 4 inches to about 14 inches, even more preferably by having a length and a width of about 18 inches and a height of about 8 inches. Using such embodiments, Applicant prefers a volume displacement when the float is in the first position is about 100 to about 1500 cubic inches, and a volume displacement when the float is in the second position is about 500 to about 2000 cubic inches.

Float construction may be achieved by a variety of different materials, yet Applicant prefers to use, at least in part, foam or a piece of foam. Floats may be made substantially of foam, essentially of foam, or may be a shell or jacket filled with foam, for example a roto- or injection-molded float filed with foam.

Referring back to the FIGS. 1a, 1b, and 2 generally, chute 10 is connected to float 6. In preferred embodiments, chute 10 is substantially vertically oriented relative to float 6. Chute 10 includes a bottom portion 10a configured to enter water 4 and a top portion 10b configured to ride above water 4, which is shown in this embodiment extending above float 6. In some embodiments, top portion 10b may be contained within float 6. Preferably trap is weighted, e.g., through chute 10 to allow bottom portion 10a to remain in the water when trap 2 is floating. Weighting may be achieved by attaching a weight to bottom portion 10a, by using a bottom portion having an inherently sufficient weight, e.g., by using a chamber 14 of sufficient weight, etc.

Chute 10 is preferably substantially tubular as shown, but others may prefer other shapes or chutes having other numbers of sides, e.g., three-, four-, five-, six-, seven-, eight-sided chutes, etc., all of which are considered to be with the scope of the present invention. Somewhat similarly, chute 10 may be constructed from a variety of material, yet Applicant prefers a plastic, e.g., polyvinyl chloride.

Chute 10 also will preferably have an interior portion that is substantially smooth, such as the internal wall of the chute, more preferably, the internal circumference of the internal wall of the chute, and even more preferably, substantially all of the internal wall of the chute from the entrance to the chamber. In other embodiments, the interior portion may be essentially smooth, or completely smooth, and such embodiments are also considered inclusive of the present invention. The purpose of the smooth portion is to allow an animal to easily fall through chute 10 into chamber 14, yet prevent animal from gaining purchase on chute wall and thereby prevent animals contained within chamber 14 from climbing up to entrance 12. In other embodiments, others may desire to employ texture or structure to achieve a similar purpose, and such embodiments are also considered to be with in the scope of the present invention. For example, others may desire to used grooves or portions of structure angled downwardly and inwardly, e.g., spikes or ridges, which allow an animal to fall from entrance 12 to chamber 14, yet that prevent an animal from climbing back to entrance 12. Any varieties of such combinations are considered to be within the scope of the present invention.

Animal entrance 12 is positioned on top portion 10b of chute 10, and is preferably, as shown, an opening defined by the chute. Others may prefer to include additional doors or passages, which are also inclusive of entrance 12 for the purposes of the present invention. Additionally, entrance 12 is positioned on the top of chute 10 with an opening size approximately equal to the diameter of chute 10, yet others in other embodiments may prefer to position entrance 12 on the side of the chute or have an entrance size of different diameter, all embodiments of which are considered to be within the scope of the present invention. For embodiments configured for muskrat-sized animals, for example, Applicant prefers an entrance opening EO having a width or diameter of about 4 to about 8 inches.

Chamber 14 is positioned on bottom portion 10a of the chute. As shown, chamber 14 is a cage attached to chute 10, but in other embodiments others may prefer other chambers, e.g., a chamber defined by a portion of chute 10, and such embodiments are considered to be within the scope of the present invention. Chamber 14 can be of various sizes depending on the embodiment, but is preferably sized to hold an animal. For example for embodiments configured to hold muskrat sized animals, Applicant prefers a chamber diameter or width CD of about 4 to 12 inches and a chamber height CH, or chamber height in combination with chute portion 10a of about 4 to about 36 inches. In preferred embodiments, chamber 14 also includes at least one aperture 14a that is large enough to allow fluid, e.g., water, to enter therethrough and small enough to prevent an animal from exiting therethrough. In some embodiments, e.g., those having a chamber defined by the chute, apertures may simply be a hole in the chute, or plurality of holes in the chute. In other embodiments, such as those having a structurally distinct chamber, e.g., a cage, the aperture may be an opening in the cage as shown. Other embodiments may include at least one aperture positioned elsewhere on the trap and in fluid communication with the chamber and such embodiments are considered to be within the scope of the present invention.

Trap 2 will also preferably include in many embodiments, anchor interface 20, which may be an aperture, protrusion, loop, hook, cleat, etc., preferably positioned on float 6 of trap 2, and configured to attach to line 22. Line 22 can be attached to anchor 24 which may be anything that anchors trap 2, e.g., an actual anchor, a dock, a buoy, etc. In many embodiments it may also be desirable to include a trap inverter 30, which is a line connected to the trap, preferably to chamber 14, that allows the trap to be upended to remove any animals contained therein. As shown, inverter is a line 30 connecting to chamber 14 at one end and line 22 at the other. A user may empty chamber 14 by pulling upward on line 30. Although inverter 30 is shown as a line, in other embodiments in may be a pole, and may attach at other places, for example, on the bottom side of float 6 or at another portion of chute 10. Similarly, in some embodiments it may be desirable to have the inverter serve as both the inverter and the anchor line. All such embodiments are considered to be within the scope of the present invention. Lines are preferably rope, but may include wire, chain, cord, string, rods, etc.

Trap 2 can be made of a variety of separate parts or may integrally formed, e.g., by integral molding, such as injection or roto molding.

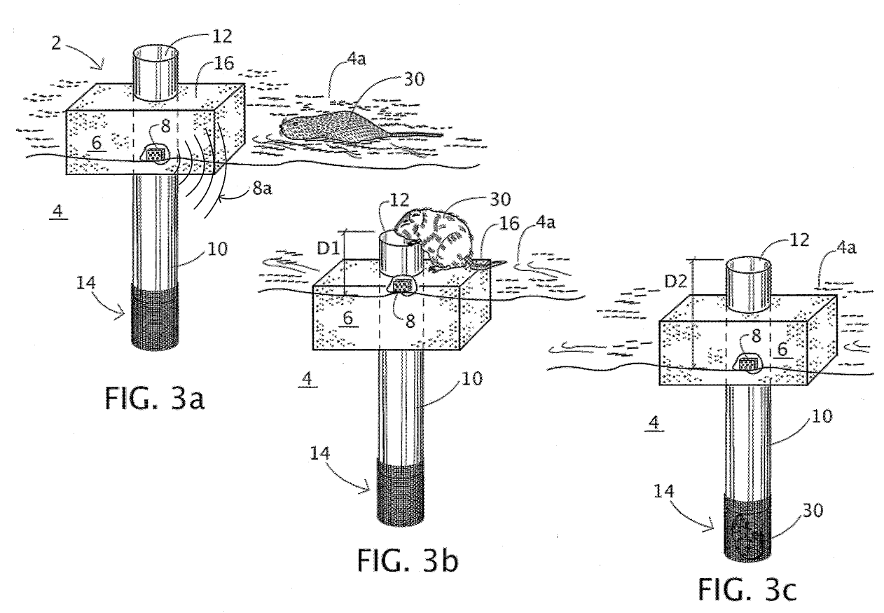

FIGS. 3a, 3b, and 3c are illustrative of an embodiment of trap 2 in operation. FIG. 3a shows trap 2 floating in water 4 at a high level. Bait 8, e.g. an apple, is positioned within chamber 10. Any variety of baits may be used, and it is not required that bait 8 float as shown. Bait scent 8a diffuses into water 4, thereby attracting animal 30, e.g., a muskrat. Animal 30 swims toward bait scent 8a and trap 2, and climbs onto float 6.

FIG. 3b shows animal 30 positioned on deck 16. As is visible, float 6 is forced to a position that is lower in the water by the weight of animal 30. As a result of this lower position, the distance D1 between the surface of the water 4a and entrance 12 appears relatively short. As animal 30 peers into entrance 12, the bait appears within easy reach of animal 30, and the relative proximity of water line 4a to entrance 12 makes it appear to animal 30, Applicant believes, that, exit may be easily achieved after bait 8 is procured. As a result, animal 30 enters trap through entrance 12.

FIG. 3c shows animal 30 positioned within chamber 14. Once animal's weight is no longer applying downward force to float 6, the buoyancy B of float 6 forces float 6 to a higher position in the water such that the distance D2 from the water line 4a to entrance 12 is greater than D1. Because of the distance D2, animal is unable to reach entrance 12 and drowns.

The efficacy of the present invention is proven. Applicant has had great success trapping and controlling populations of muskrats using a variety of the preferred embodiments discussed above. Applicant has trapped and terminated scores of muskrats using the present invention, thereby reducing damage to property and risk of injury. Applicant predicts that equal success may be achieved with other types of animals, e.g., beavers, etc., by using the teachings contained herein.

Numerous characteristics and advantages have been set forth in the foregoing description, together with details of structure and function. The novel features are pointed out in the appended claims. The disclosure, however, is illustrative only, and changes may be made in detail, especially in matters of shape, size, and arrangement of parts, within the principle of the invention, to the full extent indicated by the broad general meaning of the terms in which the general claims are expressed.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein, and every number between the end points. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10, as well as all ranges beginning and ending within the end points, e.g. 2 to 9, 3 to 8, 3 to 9, 4 to 7, and finally to each number 1, 2, 3, 4, 5, 6, 7, 8, 9 and 10 contained within the range. Additionally, any reference referred to as being “incorporated herein” is to be understood as being incorporated in its entirety. It is further noted that, as used in this specification, the singular forms “a,” “an,” and “the” include plural referents unless expressly and unequivocally limited to one referent.

I claim:

1) A trap for placing in a body of water and catching at least one animal, said trap comprising:
a float configured to provide a buoyancy when floating in said water;
a chute connected to said float, said chute being substantially vertically oriented relative to said float and having a bottom portion configured to enter said water and a top portion configured to ride above said water;
an animal entrance on said top portion of said chute;
a chamber on said bottom portion of said chute, said chamber being sized to hold said animal; and
at least one aperture positioned below said animal entrance and in fluid communication with said chamber, said at least one aperture being large enough to allow water to enter therethrough and being small enough to prevent said animal from exiting therethrough.

2) The trap of claim 1, wherein said float includes a deck configured to allow an animal to gain access to said animal entrance.

3) The trap of claim 2, wherein said deck includes a substantially horizontally portion positioned and sized to allow said animal to position thereupon.

4) The trap of claim 2, wherein said deck is substantially adjacent to said chute and vertically offset from said animal entrance.

5) The trap of claim 3, wherein said buoyancy is selected to allow said float to float at a first level when an animal is positioned on said deck and at a second higher level when an animal is not positioned on said deck.

6) The trap of claim 5, wherein said buoyancy is selected to allow said animal to gain access to said animal entrance when said float is at said first level, and wherein said buoyancy is selected to prevent said animal from escaping from said chamber when said float is at said second level.

7) The trap of claim 5, wherein said buoyancy is selected to force said animal entrance about 1 inch to about 12 inches above said water line when said float is at said first level, and wherein said buoyancy is selected to force said animal entrance about 3 inches to about 24 inches above said water when said float is at said second level, thereby preventing animals trapped in said chamber from exiting through said animal entrance.

8) The trap of claim 7, wherein said buoyancy is selected to force said animal entrance about 3 inches to about 9 inches above said water line when said float is at said first level, and wherein said buoyancy float is selected to force said animal entrance about 9 inches to about 15 inches above said water when said float is at said second level, thereby preventing animals trapped in said chamber for exiting through said animal entrance.

9) The trap of claim 8, wherein said buoyancy is selected to force said animal entrance about 4 to about 6 inches above said water line when said float is at said first level, and wherein said buoyancy is selected to force said animal entrance about 10 to about 14 inches above said water when said float is at said second level, thereby preventing animals trapped in said chamber from exiting through said animal entrance.

10) The trap of claim 5, wherein said buoyancy is selected to correspond to the weight of a muskrat such that when said a muskrat is positioned on said float said buoyancy forces said animal entrance to about 4 to about 6 inches above said water line, and wherein when said muskrat is located within said chamber, said buoyancy of said float forces said animal entrance about 10 inches to about 14 inches above said surface of said water, thereby preventing said muskrat from exiting through said animal entrance.

11) The trap of claim 1, wherein said float has a volume of about 500 cubic inches to about 5000 cubic inches.

12) The trap of claim 1, wherein said float has a volume of about 2000 cubic inches to about 2800 cubic inches.

13) The trap of claim 1, wherein said float has a volume of about 2100 to about 2600 cubic inches.

14) The trap of claim 1, wherein said float has a length and a width of about 10 inches to about 36 inches and a height of about 4 inches to about 14 inches.

15) The trap of claim 1, wherein said float has a length and a width of about 10 inches to about 24 inches and a height of about 4 inches to about 14 inches

16) The trap of claim 1, wherein said float has a length and a width of about 12 inches to about 20 inches and a height of about 4 inches to about 14 inches

17) The trap of claim 1, wherein said float has a length and a width of about 18 inches and a height of about 8 inches.

18) The trap of claim 1, wherein said float includes a piece of foam.

19) The trap of claim 1, wherein said animal entrance is defined by said top portion of said chute.

20) The trap of claim 1, wherein said chamber is defined by said bottom portion of said chute.

21) The trap of claim 1, wherein said chute is substantially tubular.

22) The trap of claim 1, wherein said chute has an interior portion that is substantially smooth.

23) The trap of claim 1, further including an anchor interface

24) The trap of claim 1, further including a trap inverter configured to allow said trap to be upended.

25) The trap of claim 24, wherein said trap inverter is a line attached to said lower portion, whereby said trap can be upended by pulling substantially upwardly on said line.

26) The trap of claim 1, wherein said trap has a weight distribution configured to allow said bottom portion to remain in the water when said trap is floating.

27) The trap of claim 1, wherein said trap is integrally formed.

28) A trap for placing in a body of water and catching at least one animal, said trap comprising:
a float having a volume of about 1500 cubic inches to about 2800 cubic inches and being configured to provide a buoyancy when floating in said water;
a substantially horizontal deck being defined by said float, said deck being positioned to allow an animal to gain access thereto and being sized to allow an animal to position thereupon;
a chute connected to said float, said chute being substantially vertically oriented relative to said float, substantially adjacent to said deck, and having a bottom portion configured to enter said water, a top portion configured to ride above said water, and an internal portion that is substantially smooth;
an animal entrance having an opening of about 3 inches to about 8 inches wide on said top portion of said chute; and
a chamber on said bottom portion of said chute, said chamber being sized to hold said animal and having at least one aperture being large enough to allow water to enter therethrough and being small enough to prevent said animal from exiting therethrough,
wherein said buoyancy is selected to allow said float to
float at a first level when an animal is positioned on said deck, thereby forcing said animal entrance down to about 4 inches to about 6 inches above said water line and allowing said animal to gain access to said animal entrance, and
float at a second higher level when an animal is not positioned on said deck, thereby forcing said animal entrance up about 9 inches to about 15 inches above said water line and preventing said animal from escaping from said chamber.

29) The trap of claim 28, further including bait positioned within said chute or said chamber.
